(19) United States
(12) Patent Application Publication
(10) Pub. No.: US 2007/0272150 A1
(43) Pub. Date: Nov. 29, 2007

(54) Device for Hardening a Coating of an Object, Which is Made of a Material Hardening Under Electromagnetic Radiation, Especially a Uv Lacquer or a Thermally Hardening Lacquer

(76) Inventors: Werner Swoboda, Boeblingen (DE); Wieland Flothmann, Moetzingen (DE)

Correspondence Address: FACTOR & LAKE, LTD, 1327 W. WASHINGTON BLVD., SUITE 5G/H, CHICAGO, IL, 60607, US

(21) Appl. No.: 10/565,753

(22) PCT Filed: Jul. 13, 2004
(86) PCT No.: PCT/EP04/07697

§ 371 Date: Mar. 27, 2007

(30) Foreign Application Priority Data
Jul. 24, 2003 (DE) 10335002.0
May 13, 2004 (DE) 102004023539.2

(51) Int. Cl. B05B 5/00

(52) U.S. Cl. 118/642

(57) ABSTRACT

Disclosed is a device for hardening the coating of an object, particularly a vehicle body (12), said coating being made of a material that hardens under electromagnetic radiation, especially a UV lacquer or a thermally hardening lacquer. The inventive device comprises at least one emitter (46, 48a, 48b, 52a, 52b) that generates electromagnetic radiation, and a system (14, 16) which conveys the object (12) into the proximity of and away from the emitter (46, 48a, 48b, 52a, 52b). The spatial position of the at least one emitter (46, 48a, 48b, 52a, 52b) or a reflector (55) that is assigned thereto can be modified by means of a motor, thus allowing even objects (12) with highly uneven and three-dimensionally curved surfaces to be conveyed into the radiation range of the emitters (46, 48a, 48b, 52a, 52b) in such a way that the surfaces are evenly exposed to a radiation quantity and radiation intensity required for hardening.

The present invention relates to an arrangement for hardening a coating of an object, in particular a vehicle body, said coating consisting of a material that hardens under electromagnetic radiation, in particular a UV lacquer or a thermally hardening lacquer, with
a) at least one emitter than generates electromagnetic radiation;
b) a conveying system that transports the object into the vicinity of and away from the emitter.

Lacquers that harden under the action of UV light have mainly been used hitherto for lacquering sensitive objects, for example wood or plastics. The advantage of these lacquers, namely that they can be polymerised at very low temperatures, is particularly manifested in such cases. The material of the objects is thereby protected against damage or outgassing. The hardening of coating materials under the action of UV light also has further advantages however, which now also makes this coating process attractive for use in other fields. These advantages include in particular the short hardening time, which is directly reflected in a reduction in the length of the coating plant, especially in those coating processes that operate in a continuous flow mode. This results in huge cost savings. At the same time the device by means of which the gases to be introduced into the interior of the arrangement are treated can be reduced in size, which likewise contributes to cost savings. Finally, the low operating temperature is advantageous on grounds of saving energy, and more especially thermal energy, also in the case of those objects that per se could withstand higher hardening temperatures.

Many of the objects that one would clearly like to coat with UV-hardening materials, for example vehicle bodies, have a highly uneven, often three-dimensionally curved surface, which means that it is difficult to introduce these objects into the radiation region of a UV emitter so that all surface regions are at about the same distance from the UV emitter and the UV radiation is incident approximately perpendicularly on the respective surface region of the object.

Known arrangements of the type mentioned in the introduction, such as have been used hitherto in the wood treatment industry, are unsuitable for this purpose since the UV emitter or emitters were arranged immovably and the objects from the conveying system were then led past the UV emitter or emitters in a more or less fixed orientation.

Recently lacquers have also been developed that harden under the action of heat in an inert gas atmosphere to form very hard surfaces. The heat can in this connection be introduced in various ways, for example by convection or by infrared emitters. In the latter case similar problems arise as are described above in connection with the use of UV emitters. In particular all surface regions of the object to be lacquered should be led past the infrared emitter at approximately the same distance from the emitter.

The object of the present invention is to configure an arrangement of the type mentioned in the introduction so that coatings on highly uneven objects of complicated shape, in particular car bodies, can also be hardened to give good results.

This object is achieved according to the invention by the fact that the spatial orientation of the at least one emitter or a reflector associated therewith can be altered by means of a motor.

The alterability of the spatial orientation of the at least one emitter or of a reflector associated therewith enables the position of the radiation sources, which in this connection are also understood to include a reflector, can be adapted to the spatial shape of the coated object so that complicated three-dimensional surfaces can also be uniformly exposed to an amount of radiation and a radiation intensity that are necessary to harden the material. A complete hardening in fact only occurs if on the one hand the electromagnetic radiation is incident on the coating with an intensity lying above a threshold value, and on the other hand this intensity is also maintained for a specific period. If the intensity is too low a polymerisation reaction does not take place or only incompletely, while if the irradiation time is too short—even with a sufficient intensity—similarly only an incomplete hardening is achieved.

If now according to the invention the coated object is led past the emitter or emitters by means of the conveying system, then the spatial orientation of the emitter or emitters or reflectors associated therewith will in a preferably program-controlled manner automatically track the external contours of the object. It is thereby possible in a simple manner to harden uniformly and completely all surface regions of the relevant object in the action region of the electromagnetic radiation.

Preferably a first emitter extends within a plane that runs substantially parallel to a transporting plane of the conveying system, wherein the first emitter can be driven by a motor in a direction perpendicular to the transporting plane. Numerous objects to be coated, for example bodies of small buses, have in fact at least roughly parallel flat side faces, whereas a boundary surface facing away from the transporting plane is more markedly contoured and is thus uneven. If in such a case the parallel side faces too of the object are coated and therefore have to be hardened, the arrangement preferably comprises at least two further emitters that are arranged on both sides of a conveying stretch of the conveying system.

If these side faces are however also fairly highly contoured, then it is furthermore preferred if the at least two further emitters can be driven by means of a motor in directions perpendicular to a conveying direction of the conveying system. In this way the distance between the side faces of the object and the at least two further emitters can automatically change while the object is guided between the emitters.

An even better matching to the lateral external contours of the object can be achieved if the at least two further emitters can in each case be tilted or swivelled by means of a motor about an axis parallel to the conveying direction.

Simplest of all, the emitters can be arranged within the arrangement if they are secured to a gantry that spans, like a bridge, a conveying stretch of the conveying system. In this way a similar arrangement is achieved as is known for example from car wash facilities.

In principle the arrangement can also be controlled manually if the object is observed by an operator while it passes the at least one emitter. It is preferred however if the arrangement comprises a control device by means of which the spatial orientation of the at least one emitter or of the reflector associated therewith can be automatically adapted to the contours of the object.

Preferably the spatial orientation of the at least one emitter or of the reflector associated therewith can be altered by the control device in such a way that, during a conveying movement of the object past the at least one emitter, the amount of electromagnetic radiation incident per unit area on the material and its intensity do not fall below threshold values necessary for the hardening and that can be predetermined in each case. In photometry this amount is termed the radiation exposure and is given in the units Watts/M² or J/cm². For conventional UV lacquers for example the necessary radiation exposure is a few J/cm².

Since a slight “over-exposure” of the coating does not in general damage the latter, this control criterion is sufficient to harden the whole surface uniformly. With particularly sensitive coatings it may however also be expedient to design the control device so that the amount of electromagnetic radiation incident per unit area on the material is substantially constant. If this constant value is only slightly above the threshold necessary for the hardening, then a stronger “over-exposure”, which for example can lead to an embrittlement or a discolouration, is avoided.

So that the control device can alter the spatial orientation of the at least one emitter or of a reflector associated therewith in the manner outlined hereinbefore, the spatial data of the object must be known to the control device. These spatial data may for example be made available by a master data processing unit. The control device may however also comprise a memory for storing spatial data of the object, so that these data can also be available locally.

To determine the spatial data a measuring station by means of which the spatial data of the object can be determined may be arranged in front of, optionally also immediately in front of, the at least one emitter in the conveying direction.

In a particularly simple implementation the measuring station simply comprises one or more light barriers that are preferably arranged in the immediate vicinity of the at least one emitter and that co-operate with the control device. If the object to be irradiated interrupts a light barrier, a corresponding evasive movement of the affected emitter is triggered, as is similarly known from car wash facilities or collision prevention devices.

Digital image processing and recognition of video images of the object provides a more accurate way of precisely determining the spatial shape. The measuring station then includes a video camera and a device for digital image recognition.

An even more accurate determination of the spatial shape is possible if the measuring station comprises at least one optical scanner, which may for example contain an infrared light source, by means of which the object can be scanned in at least one direction.

Particularly preferred is that embodiment of the invention in which the arrangement comprises an at least approximately gas-tight housing that is impermeable to electromagnetic radiation, into the interior of which the object can be driven and in which the at least one emitter is arranged. This housing ensures that no electromagnetic radiation and no gases can escape in the lateral direction, which is necessary as regards the health and safety of the operating staff.

It is particularly preferred if a protective gas can be fed into the interior of the housing. The primary function of the protective gas is to prevent the presence of oxygen in the radiation region of the emitters, since this oxygen could be converted into the harmful compound ozone, especially under the influence of UV light, and is also damaging in the polymerisation reaction.

The protective gas may be heavier than air, in particular carbon dioxide, or also lighter than air, in particular helium.

If an inlet for the protective gas is provided in the immediate vicinity of the at least one emitter, then this protective gas can at the same time serve as cooling gas for the emitter. Alternatively or in addition to this, at least one inlet may however also be aligned so that the protective gas leaving the inlet is aimed directly onto the momentarily irradiated surface. In this way it is ensured that the proportion of undesirable foreign gases is very small at the reaction site at which the electromagnetic radiation effects the hardening.

The housing may, in the vicinity of the at least one emitter, be provided on its internal surfaces with a reflecting layer. Emitters of lower output may thereby be used.

The reflection effect is enhanced by the fact that the layer comprises a plurality of unevennesses. The reflections occur under these circumstances at widely different angles, whereby undesired concentrations of radiation are avoided.

It is particularly convenient if the reflecting layer consists of aluminium foil. This has a very good reflectivity for electromagnetic radiation and is inexpensive. Furthermore, an aluminium foil can easily be crumpled, whereby the aforedescribed unevennesses can be formed in a simple way.

Instead of filling the whole housing with protective gas, a container open to a transporting plane and which can be filled with protective gas may also be arranged in the housing. In the case of a container that is open at the top the protective gas should be heavier than air; in the case of a dome-shaped container open at the bottom the protective gas should be lighter than air. Whether a container that is open at the top or bottom is preferred in an individual case depends inter alia on the type of conveying system that is used. In the case of telphers for example a container open at the top is more favourable since the object can then be introduced relatively easily from above into the container.

A lock (air-lock) for introducing and removing the object may be provided in each case at the inlet and at the outlet of the housing. These locks prevent relatively large amounts of air passing from the surrounding atmosphere into the housing when the object is introduced into and removed from the housing. Also, the locks protect operating staff from harmful radiation, for example UV light.

In the case of objects containing cavities it may furthermore be expedient to arrange a further inlet for protective gas within the lock on the inlet side, so that the cavities are flushed with protective gas, air contained therein thereby being displaced.

Since however the penetration of air, in particular oxygen, into the interior of the housing cannot be completely suppressed even with locks, a device for removing oxygen from the atmosphere contained in the interior of the housing is expediently provided. This device may include a catalyst for the catalytic binding of the oxygen, a filter for absorbing oxygen or also a filter for adsorbing oxygen.

Instead of moving, swivelling or otherwise changing the position of the at least one emitter itself, the shape of a reflector associated with this emitter can also be altered in order to change the radiation concentration. Such a reflector may for example be constructed from a plurality of reflecting segments that can be adjusted individually.

If a moveable reflector is associated with at least one of the emitters on the side facing away from the object, an additional adaptation of the irradiation direction to the contour of the surface of the object to be treated is then possible.

If the coating material initially still contains a relatively large amount of solvent, as is the case for example with water-based lacquers, the arrangement may include a preheating zone for removing the solvent from the material of the coating.

If on the other hand pulverulent materials are to be processed, the arrangement may comprise a corresponding preheating zone for gelling this pulverulent material.

At the outlet side the arrangement may include a post-heating zone for completing the hardening.

The electromagnetic radiation is preferably UV light or infrared radiation.

Further features and advantages of the invention follow from the following description of an embodiment with the aid of the drawings, in which:

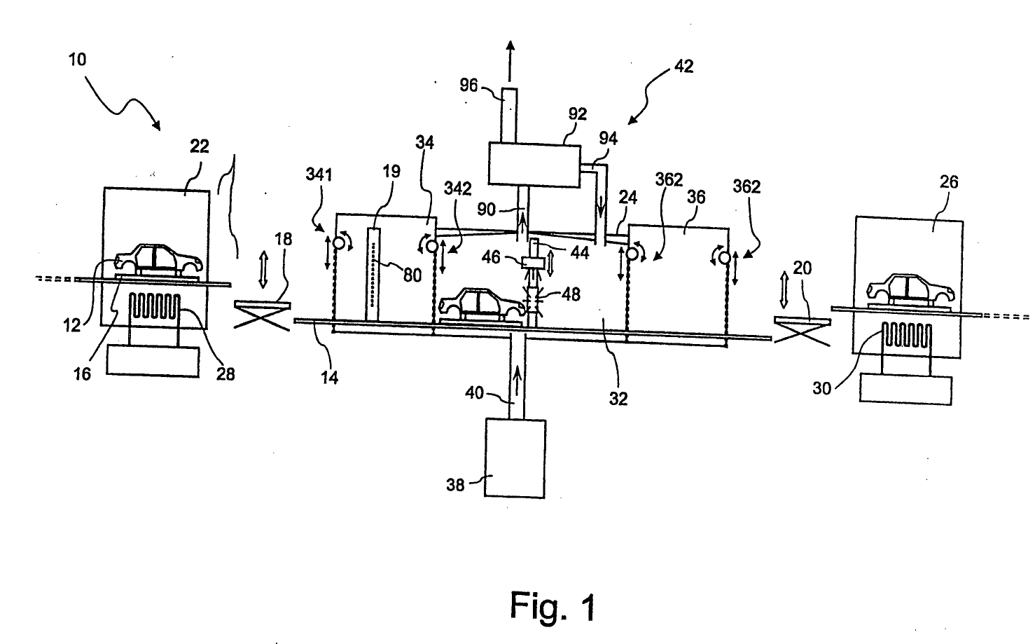

FIG. 1 is a highly simplified longitudinal section, not to scale, through an arrangement for hardening a UV lacquer on vehicle bodies;

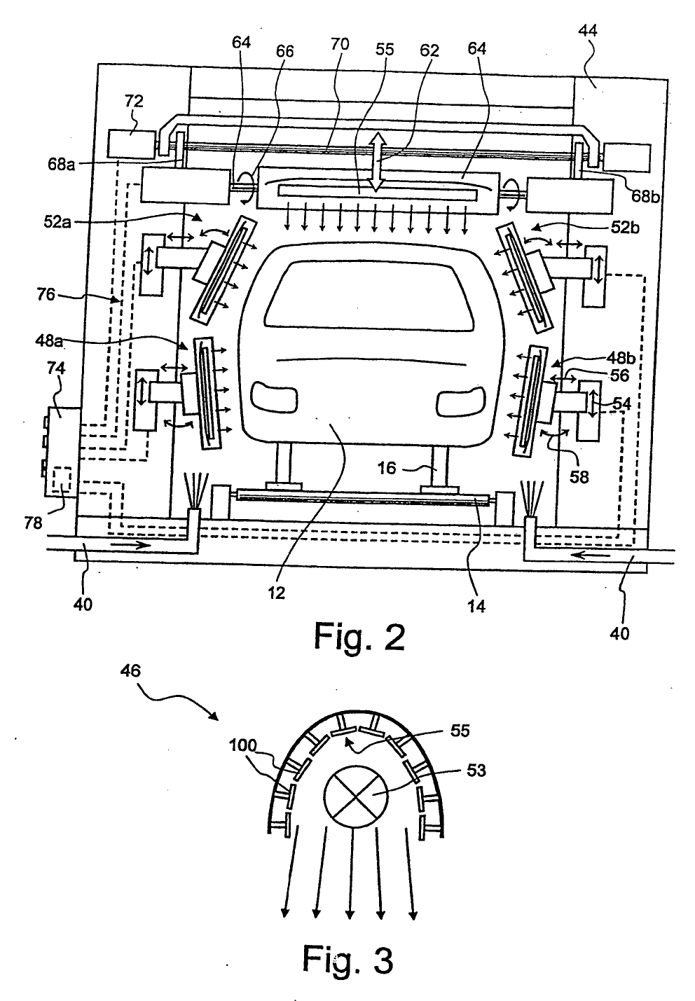

FIG. 2 is a front view of a gantry of the arrangement illustrated in FIG. 1;

FIG. 3 is a cross-section of a UV emitter together with associated reflector.

A highly simplified longitudinal section (not to scale) of an arrangement for hardening UV lacquers is shown in FIG. 1 and is denoted overall by the reference numeral 10. The hardening arrangement 10 shown by way of example is part of a paint shop that is provided for applying a multilayer coating onto pre-assembled vehicle bodies 12.

The hardening arrangement comprises a system known per se for conveying the vehicle bodies 12, which in the illustrated embodiment comprises a roller conveyor 14, skid carriers 16 mounted thereon, as well as a first lifting platform 18 and a second lifting platform 20. With the aid of this conveying system the vehicle bodies 12 are fed to the hardening arrangement 10 and are transported through the individual stations of the hardening arrangement 10. These stations include a preheating zone 22, a measuring station 19, an irradiation tunnel 24 and a post-heating zone 26.

The preheating zone 22 and the post-heating zone 26 contain in each case heating devices in the form of hot air heaters and identified by the reference numerals 28 and 30, by means of which the temperature in the preheating zone 22 and in the post-heating zone 26 can be raised. Alternatively heating may suitably be provided by IR radiators or by means of a magnetron for generating microwaves. The preheating zone 22 may perform various functions depending on the type of coating material: if this material includes solvent-based substances, such as for example a water-based lacquer, then the solvents are largely removed. If the substance is a powder material, the pre-heating zone 22 serves to gel the powder partially and in this way prepare it for the polymerisation reaction.

The irradiation tunnel 24 is a cabin that is largely impermeable to air and UV light, whose interior 32 is accessible to vehicle bodies 12 only through an inlet lock 34 and an outlet lock 36. In the illustrated embodiment the inlet lock 34 and the outlet lock 36 are in each case designed as double locks with two moveable roller gates 341, 342 and 361, 362.

The interior 32 of the irradiation tunnel 24 can be filled with a protective gas that is stored in a gas container 38 and can be introduced into the interior through a line 40 terminating in the floor of the interior 32. In the illustrated embodiment the protective gas is carbon dioxide. Since gaseous carbon dioxide is heavier than air, it completely fills the interior 32 of the irradiation tunnel 24 from the bottom to the top. If a gas that is lighter than air, for example helium, is used as protective gas, then the protective gas should preferably be introduced from above into the interior 32. The amount of protective gas fed through the lines 14 is in dynamic equilibrium with the amount of protective gas that escapes inter alia through the inlet and outlet locks 34 and 36.

In addition the interior 32 is connected to a regeneration circulation 42 by means of which oxygen can be removed from the atmosphere contained in the interior 32.

A gantry 44 is furthermore arranged in the interior 32, which extends over the roller conveyor 14 in the manner of a bridge. A plurality of UV emitters are secured to the gantry 44, namely a horizontally aligned ceiling emitter 46 as well as a plurality of vertically aligned lateral emitters 48. The arrangement of the UV emitters 46, 48 is described hereinafter with the aid of FIG. 2.

FIG. 2 is a highly diagrammatic front view of the gantry 44 with UV emitters secured thereon. The gantry 44 spans the roller conveyor 14 in the manner of a bridge, on which conveyor the skid carriers 16 together with the vehicle bodies 12 secured thereon can be led through the gantry 44. The ceiling emitter 46, a pair of lower lateral emitters 48a, 48b arranged on both sides of the roller conveyor 14 as well as a pair of upper lateral emitters 52a, 52b arranged on both sides of the roller conveyor 14 are secured to the gantry 44. The ceiling emitter 46 as well as the four lateral emitters 48a, 48b and 52a, 52b contain in each case a rod-shaped light source 53 and an associated reflector 55 arranged behind the said source.

As indicated by the double arrows in FIG. 2, the spatial orientation of the lower lateral emitters 48a, 48b and of the upper lateral emitters 52a, 52b can be widely altered by means of adjustment motors (not shown in more detail). This is illustrated by the example of the lower, right-hand lateral emitter 48b. This lateral emitter 48b can be adjusted in the vertical direction, i.e. in the direction of the double arrow 54, as well as parallel to the transverse axis of the vehicle body 12, i.e. in the direction of the double arrow 56. In addition the lateral emitter 48b can be swivelled about an axis parallel to the conveying direction, as indicated by a double arrow 58.

The ceiling emitter 46 can be driven in the vertical direction (arrow 62) and furthermore can be rotated about an axis 64, as indicated by double arrows 66. The lateral suspensions of the ceiling emitter 46 are held in vertically-running, slit-shaped guides and are suspended on tracks 68a, 68b on a shaft 70 extending over the whole width of the gantry 44. The shaft 70 can be caused to rotate about its longitudinal axis via a drive 72, whereby the tracks 68a, 68b can be rolled up or unrolled and in this way their length can be altered. The ceiling emitter 46 is at the same time correspondingly lowered or raised.

Instead of a unitary ceiling emitter 46 a ceiling emitter subdivided into two or more individual segments may also be provided. By matching the arrangement of the individual segments to the contour of the upwardly-facing surface of the vehicle body 12, a largely constant irradiation distance can be maintained even if this surface is highly curved.

If UV lacquer that is located on internal surfaces of the vehicle body 12 and cannot be reached from outside by the UV emitters 46, 48a, 48b, 52a, 52b is to be hardened, an additional UV emitter may be used that is mounted on a moveable arm that can be introduced into the interior of the vehicle body 12.

By means of a control device 74 that is connected to the individual adjustment motors via control lines shown by dotted lines in FIG. 2 and identified overall by the reference numeral 76, the UV emitters 46, 48a, 48b, 52a, 52b can be aligned with respect to the vehicle body 12 so that its external contours are uniformly irradiated from all sides with UV light. The distance between the external contour of the vehicle body 12 and the UV emitters 46, 48a, 48b, 52a, 52b is in this connection chosen so that the total amount of UV light, i.e. the radiation exposure, to which the lacquered surface is exposed exceeds the threshold value necessary for a polymerisation of the lacquer surface. Since modern vehicle bodies 12 often have a relatively highly curved external contour, the positions of the ceiling emitter 46, of the side emitters 48a, 48b and 52a, 52b and optionally of the reflectors 55 during the passage of the vehicle body 12 through the gantry 44 are continuously adapted to the external contour of the vehicle body 12 traversing the gantry 44.

The spatial data of the vehicle body 12 necessary for this purpose are stored in a memory 78 in the control device 74. These spatial data can be accessed, for example by a master data processing unit in which relevant data for all the vehicle bodies 12 passing through the hardening arrangement 10, such as the type and colour of the lacquering and body type and shape, are stored. A reading device that recognises the type of vehicle body 12 entering the irradiation tunnel 24 is then simply required, so that the spatial data associated with this type can be accessed.

Alternatively or for control purposes, in addition to this it is possible to determine the necessary spatial co-ordinates also with the measuring station 19 situated in front (upstream) of the gantry 44, the said station being arranged within the inlet lock 34 (see FIG. 1). The measuring station 19 also has a gantry-shaped frame on which a plurality of optical scanners 80 with infrared light sources are secured in the vertical direction as well as transverse to the conveying direction 82. The scanners 80 determine the external contour of the vehicle body 12 during its passage through the measuring station 19.

The operation of the hardening arrangement 10 is described hereinafter.

It is assumed that several lacquer layers have already been applied in an upstream-located coating device of the paint shop. The top lacquer layer is a clear lacquer, which is applied as powder to the already-existing lacquer layers. Under the influence of UV light the clear lacquer polymerises and thereby hardens. A precondition for this is that on the one hand the pulverulent lacquer is first of all converted into a quasi-liquid, gel-like state. The preheating zone 22, in which a vehicle body 12 introduced therein is heated to a temperature of about 90° C., serves for this purpose. At this softening temperature the powder is converted into the aforementioned gel-like state.

From the preheating zone 22 the skid carrier 16 together with the vehicle body 12 mounted thereon is lowered via the first lifting platform 18 and is placed on a lower-lying section of the roller conveyor 14. By successive opening and closing of the roller gates 341, 342 of the inlet lock 34 the vehicle body 12 is introduced into the irradiation tunnel 24 without any significant amounts of the protective gas contained therein being able to penetrate outwardly.

The actual hardening of the clear lacquer, which is now in a gel-like state, takes place in the interior 32 of the irradiation tunnel 24 by means of UV irradiation. The protective gas displaces the air originally contained in the interior 32 and thereby prevents the UV light converting the molecular atmospheric oxygen into ozone, which would slow down the polymerisation reaction.

Since protective gas is lost in particular due to the opening of the inlet lock 34 and outlet lock 36, protective gas is constantly introduced into the interior 32 through the gas channel 40 during the operation of the hardening arrangement 10.

The purpose of the regeneration cycle 42 is to remove oxygen that is introduced via the vehicle body 12 into the interior 32 or that enters during the opening of the inlet lock 34 or outlet lock 36, from the atmosphere in the interior 32. For this purpose protective gas is constantly removed from the interior 32 via a line 90 and is passed for example over a catalyst 92 that catalytically binds the oxygen. Part of this protective gas is returned via the line 94 to the interior 32 of the irradiation tunnel 24, while another part is discharged via a line 96 into the ambient atmosphere.

Instead of a catalyst 90 the regeneration cycle 42 may also contain an oxygen-adsorbing or oxygen-absorbing filter.

After passing through the gantry 44 the vehicle body 12 leaves the irradiation tunnel 24 and is raised by the second lifting platform 20 to a higher-lying section of the roller conveyor 14 and introduced into the post-heating zone 26. The vehicle body 12 remains for about 5 to 10 minutes in this post-heating zone, which is at a temperature of about 105° C., during which time the polymerisation reaction comes to completion.

FIG. 3 shows the ceiling emitter 46 in an enlarged cross-sectional view. The reflector 55 associated with the ceiling emitter 46 is in this embodiment subdivided into a plurality of individual segments 100, which can be individually adjusted by means of actuating drives not shown in more detail in FIG. 3. In this way the alignment characteristics of the ceiling emitter 46 can be purposefully altered, whereby the radiation effect of the ceiling emitter 46 can be adapted for example to different surface inclinations.

The above embodiments are used to harden lacquers under the action of UV light. They can however also be employed with those lacquers that harden under the action of heat, in particular in an inert gas atmosphere, thus for example in a CO₂ or nitrogen atmosphere. In this case basically only the aforedescribed UV emitters need to be replaced by IR emitters. Other structural modifications connected with the change of electromagnetic radiation are known to the person skilled in the art and do not need to be described in more detail here.

1. An arrangement for hardening a coating of an object, said coating including a material that hardens under electromagnetic radiation, the arrangement including
at least one emitter that generates electromagnetic radiation;
a conveying system that transports the object into the vicinity of and away from the emitter;
wherein
the spatial orientation of the at least one emitter or of a reflector associated therewith can be changed by means of a motor.

2. Arrangement according to claim 1, wherein a first emitter extends within a plane that runs substantially parallel to a transporting plane of the conveying system and that the first emitter can be driven by means of a motor in a direction perpendicular to the transporting plane.

3. Arrangement according to claim 2, wherein the arrangement comprises at least two further emitters that are arranged on both sides of a conveying stretch of the conveying system.

4. Arrangement according to claim 3, wherein the at least two further emitters can be driven by means of a motor in directions perpendicular to a conveying direction of the conveying system.

5. Arrangement according to claim 4, wherein the at least two further emitters can in each case be tilted or swivelled by means of a motor about an axis parallel to the conveying direction.

6. Arrangement according to one of claim 3 wherein the emitters are secured to a gantry that spans a conveying stretch of the conveying system in a bridge-like manner.

7. Arrangement according to claim 1, wherein the arrangement comprises a control device by means of which the spatial orientation of the at least one emitter or of the reflector associated therewith can automatically be adapted to the contours of the object.

8. Arrangement according to claim 7, wherein by means of the control device, the spatial orientation of the at least one emitter or of the reflector associated therewith can be altered in such a way that, during a conveying movement of the object past the at least one emitter the amount of electromagnetic radiation incident per unit area on the material and its intensity in each case does not fall below predeterminable threshold values necessary for the hardening.

9. Arrangement according to claim 8, wherein the control device is designed so that the amount of electromagnetic radiation incident per unit area on the material remains substantially constant.

10. Arrangement according to claim 8, wherein that the control device includes a memory for storing spatial data of the object.

11. Arrangement according to claim 1, wherein a measuring station is located upstream of the at least one emitter in the conveying direction, by means of which station the spatial data of the object can be determined.

12. Arrangement according to claim 11, wherein the measuring station comprises at least one light barrier.

13. Arrangement according to claim 11, wherein the measuring station comprises a video camera and a device for digital image recognition.

14. Arrangement according to one of claim 11, wherein the measuring station comprises at least one optical scanner by means of which the object can be scanned in at least one direction.

15. Arrangement according to claim 14, wherein the optical scanner comprises an infrared light source.

16. Arrangement according to claim 1, further comprising a housing that is at least virtually gas-tight and impermeable to electromagnetic radiation, into the interior of which the object can be introduced and in which the at least one emitter is arranged.

17. Arrangement according to claim 16, wherein a protective gas can be fed into the interior of the housing.

18. Arrangement according to claim 17, wherein the protective gas is heavier than air.

19. Arrangement according to claim 18, wherein the protective gas is lighter than air.

20. Arrangement according to claim 17, wherein an inlet for the protective gas is provided in the immediate vicinity of the at least one emitter.

21. Arrangement according to claim 16, wherein the housing is covered with a reflecting layer in the vicinity of the at least one emitter.

22. Arrangement according to claim 21, wherein the reflecting layer comprises a plurality of unevennesses.

23. Arrangement according to claim 21, wherein the reflecting layer includes of an aluminium foil.

24. Arrangement according to claim 16, wherein a container open to a transporting plane is arranged in the housing, which container can be filled with the protective gas.

25. Arrangement according to claim 16, wherein a lock for respectively introducing and removing the object is arranged at an inlet and at an outlet of the housing.

26. Arrangement according to claim 25, wherein an inlet for protective gas is arranged within the entry-side lock in such a way that a cavity present in the object is flushed out with protective gas.

27. Arrangement according to claim 16, wherein a device is provided for removing oxygen from the atmosphere contained within the housing.

28. Arrangement according to claim 27, wherein the device for removing oxygen comprises a catalyst for the catalytic binding of the oxygen.

29. Arrangement according to claim 27, wherein device for removing oxygen comprises a filter for absorbing oxygen.

30. Arrangement according to of claim 27, wherein the device for removing oxygen comprises a filter for adsorbing oxygen.

31. Arrangement according to claim 1, wherein a reflector for concentrating the radiation is associated with the at least one emitter, the shape of which reflector can be altered in order to change the radiation concentration.

32. Arrangement according to claim 1, wherein a moveable reflector is associated with the at least one emitter on the side facing away from the object.

33. Arrangement according to one claim 1 wherein it comprises a preheating zone for removing solvents from the material of the coating.

34. Arrangement according to claim 1, further comprising a preheating zone for gelling pulverulent material of the coating.

35. Arrangement according to claim 1, further comprising a post-heating zone for completing the hardening.

36. Arrangement according to claim 1, wherein the electromagnetic radiation is UV light.

37. (canceled)

38. The arrangement of claim 18, wherein the protective gas is carbon dioxide.

39. The arrangement of claim 19, wherein the protective gas is helium.
